(19) United States
(12) Patent Application Publication
(10) Pub. No.: US 2003/0001413 A1
(43) Pub. Date: Jan. 2, 2003

(54) Permanently deformable headrest for a vehicle seat and method of use

(76) Inventor: Donald Albrecht, Santa Monica, CA (US)

Correspondence Address: Timothy T. Tyson, Freilich, Hornbaker & Rosen, Suite 1220, 10960 Wilshire Blvd., Los Angeles, CA, 90024, US

(21) Appl. No.: 09/895,653

(22) Filed: Jul. 2, 2001

(51) Int. Cl. B60N 2/42

(52) U.S. Cl. 297/216.12

(57) ABSTRACT

A permanently deformable headrest (20) for a vehicle seat (502) includes a permanently deformable structure which permanently bends when exposed to the force of a passenger's head (501) being thrown back against the headrest (20) during a rear end collision. The permanently deformable structure dissipates much of the kinetic energy of the passenger's head (501), thereby substantially reducing the reactive forward force which can cause whiplash injuries.

### TECHNICAL FIELD

The present invention pertains generally to vehicle seats, and more particularly to a headrest which in an accident is permanently deformed by the force of a passenger's head, thereby absorbing energy and reducing whiplash.

### BACKGROUND ART

Headrests for vehicle seats are well known in the art. For example, U.S. Pat. No. 3,547,486 shows an angularly and vertically adjustable head rest which is secured to the top of a back rest forming part of a vehicle seat. The head rest may be immobilized in a desired height position by a locking mechanism disposed entirely within, and surrounded by, the foam plastic cushion of the head rest.

U.S. Pat. No. 5,769,489 illustrates an energy absorbing support for vehicular passengers which comprises apparatus for preventing or limiting spinal injuries to a passenger seated in a forward facing position in a moving vehicle during vehicular impact or sudden deceleration. The apparatus includes a vehicle installed supporting seat for the passenger, the seat having a support portion behind the seated passenger which includes a resilient surface in contact with the supported passenger. The resilient portion is supported on an underlying stiff support shell. The support shell is rearwardly displaceable upon being subjected to impressed forces generated from the passenger pressing against the resilient surface of the support portion as a result of a rear end impact on the vehicle. A controllably deformable energy absorbing crush zone is positioned to the rear of the shell and is compressed by rearward displacement of the shell. The support portion acts to decelerate the supported spine of the passenger during a vehicle rear end impact, while the controlled deformation of the crush zone absorbs energy to prevent or limit spinal injuries of the passenger.

U.S. Pat. No. 5,823,619 discloses a vehicle seat which includes a back rest with a headrest. A flexible traction element extends through the interior of the back rest and is adapted to respond to the movement of an inertial mass shifted in a rear end impact and to cause a displacement of an attachment means of the traction element on the headrest. The displacement is converted in a mechanical setting mechanism, coupled with the traction element, into a movement of the headrest toward the head of the occupant to reduce the distance between the headrest and the head of the occupant.

U.S. Pat. No. 5,836,648 shows a vehicle seat having a seat part and a backrest adjustable in inclination relative to the seat part. The backrest is configured in two parts, a top backrest part and a bottom backrest part. The top backrest part pivots relative to the bottom backrest part. The holding force of a clamping device is overcome in a crash due to movement of the person in the seat. The top backrest part moves to intercept the person in the seat.

U.S. Pat. No. 5,961,182 describes a seat having a resilient surface in contact with the supported passenger. The resilient surface is supported on an underlying stiff support shell. The support shell is rearwardly displaceable in a rear end collision by the forces generated by the passenger pressing against the resilient surface. A controllably deformable energy absorbing crush zone is disposed to the rear of the shell and is compressed by rearward displacement of the shell. The support portion acts to decelerate the supported spine of the passenger during a vehicle rear end impact, while the controlled deformation of the crush zone absorbs energy, to prevent or limit spinal injuries to the passenger.

U.S. Pat. No. 6,024,405 depicts a head restraint assembly having an adjustable head restraint member which is securable in position between a forward position and a rearward position by a helical coil locking member. The locking member is in a normally relaxed state of smaller internal diameter than the external diameter of a transverse support rod with which it is engaged. Rotation of one end of the locking member with respect to the other end partially unwinds the locking member, thereby releasing its grip on the support rod.

### DISCLOSURE OF INVENTION

The present invention is directed to an improved headrest for a vehicle seat which permanently deforms during a rear end collision. The deformation absorbs and dissipates much of the kinetic energy of a passenger's head, and thereby minimizes the opposite forward whipping action of the head and neck which occurs immediately after a collision. In one embodiment of the present invention, the posts which support the padded portion of the headrest are permanently deformable. In another embodiment, spaced rods absorb the energy of the rearwardly moving head.

In accordance with a preferred embodiment of the invention, a permanently deformable headrest for a vehicle seat has a permanently deformable structure, so that when a passenger's head is thrown back against the headrest during a rear end collision, the structure is permanently deformed in a rearward direction, thereby absorbing much of the kinetic energy of the passenger's head. The force of the passenger's head causes the permanently deformable structure to exceed its elastic limit, and thereby assume a permanently deformed or bent shape.

In accordance with an important aspect of the invention, the permanently deformable structure includes at least one permanently deformable post which mounts the headrest to the vehicle seat.

In accordance with an important feature of the invention, the permanently deformable structure includes at least one horizontal permanently deformable member.

In accordance with another important aspect of the invention, the permanently deformable structure includes at least one vertical permanently deformable member.

In accordance with another important feature of the invention, once the permanently deformable headrest has been deformed, it must be replaced with a new undeformed headrest, or in the first embodiment the deformable posts must be replaced.

Other features and advantages of the present invention will become apparent from the following detailed description, taken in conjunction with the accompanying drawings, which illustrate, by way of example, the principles of the invention.

### BRIEF DESCRIPTION OF DRAWINGS

FIG. 1 is a prior art side elevation view of a passenger sitting in a vehicle seat having a conventional headrest;

FIG. 2 is a prior art side elevation view of the passenger's head being thrown back against the headrest during a rear end collision;

FIG. 3 is a prior art side elevation view of the passenger's head being thrown or whipped forward immediately after the rear end collision;

FIG. 4 is a side elevation view of a passenger sitting in a vehicle seat having a permanently deformable headrest in accordance with the present invention;

FIG. 5 is a rear elevation view of the permanently deformable headrest;

FIG. 6 is a side elevation view of the passenger's head being thrown back against the permanently deformable headrest causing the headrest to permanently bend toward the rear of the vehicle;

FIG. 7 is a side elevation view of the passenger's head being thrown forward;

FIG. 8 is a side elevation view of a second embodiment of the permanently deformable headrest;

FIG. 9 is a rear elevation view of the second embodiment;

FIG. 10 is a side elevation view of the passenger's head being thrown back against the second embodiment permanently deformable headrest;

FIG. 11 is a side elevation view of the passenger's head being thrown forward;

FIG. 12 is an alternative version of the second embodiment;

FIG. 13 is another alternative version of the second embodiment; and,

FIG. 14 is a third alternative version of the second embodiment.

### MODES FOR CARRYING OUT THE INVENTION

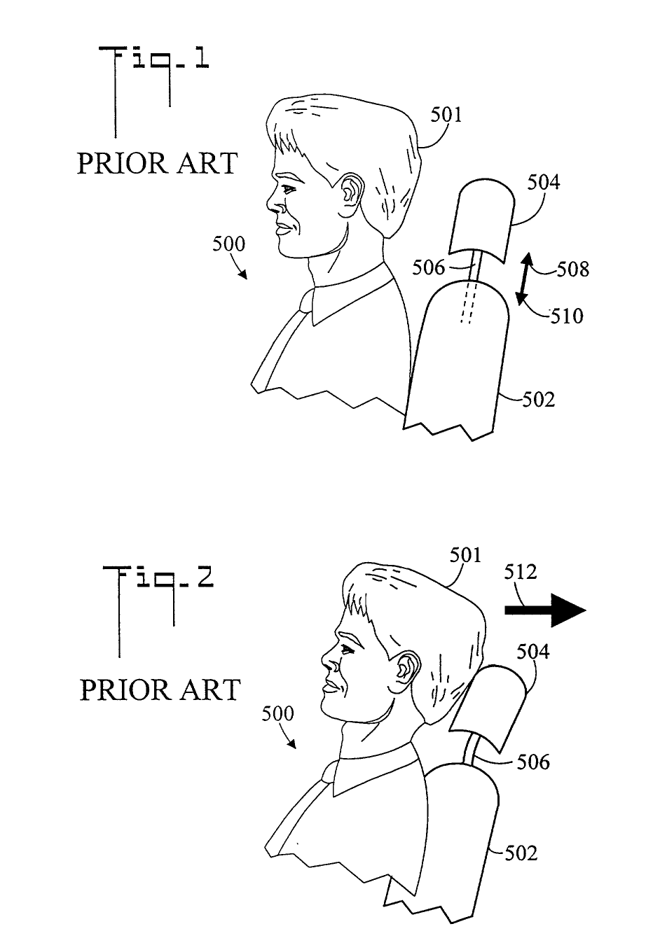

Referring initially to FIG. 1, there is illustrated a side elevation view of either a driving or non-driving passenger 500 sitting in a forward facing vehicle seat 502 having a conventional headrest 504. Headrest 504 is usually mounted to the top of seat 502 by a post or posts 506 which allow headrest 504 to be moved up and down in directions 508 and 510 respectively. Posts 506 slidably enter a support means located within vehicle seat 502. When in the shown up position, headrest 504 is intended to stop the rearward movement of the head 501 of passenger 500 during a rear end collision.

FIG. 2 is a side elevation view of the passenger's head 501 being thrown back in direction 512 against headrest 504 during a rear end collision.

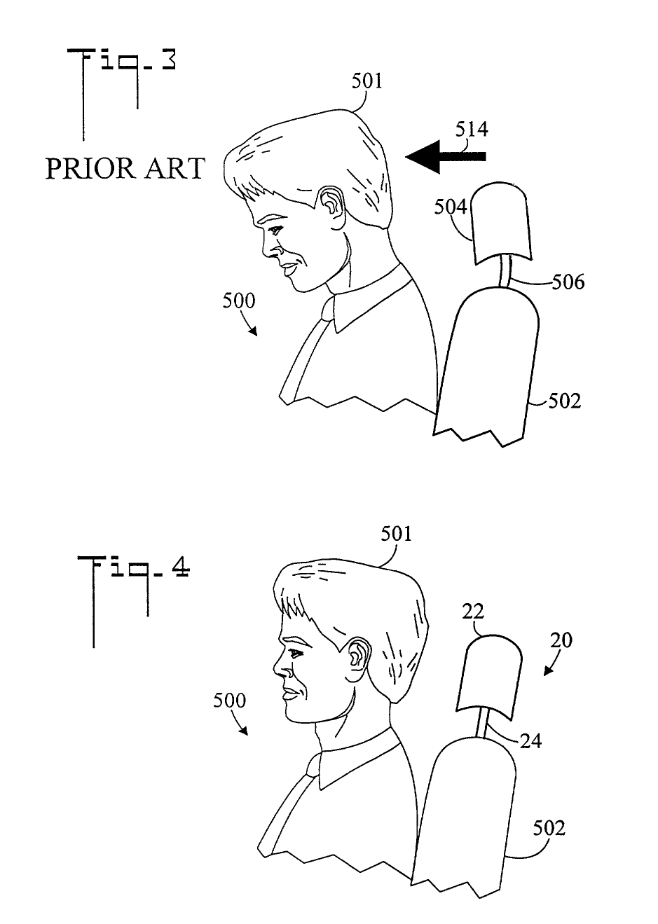

FIG. 3 is a side elevation view of the passenger's head 501 being thrown forward in direction 514 immediately after the rear end collision. That is, FIGS. 2 and 3 comprise a backward and forward cycle which the passenger's head 501 experiences during a rear end collision. The head 501 is first thrown back by the force of the collision, and then thrown forward by the whipping action of seat 502 and headrest 504 when the collision force abates. It is this rapid back and forth action that results in many whiplash injuries.

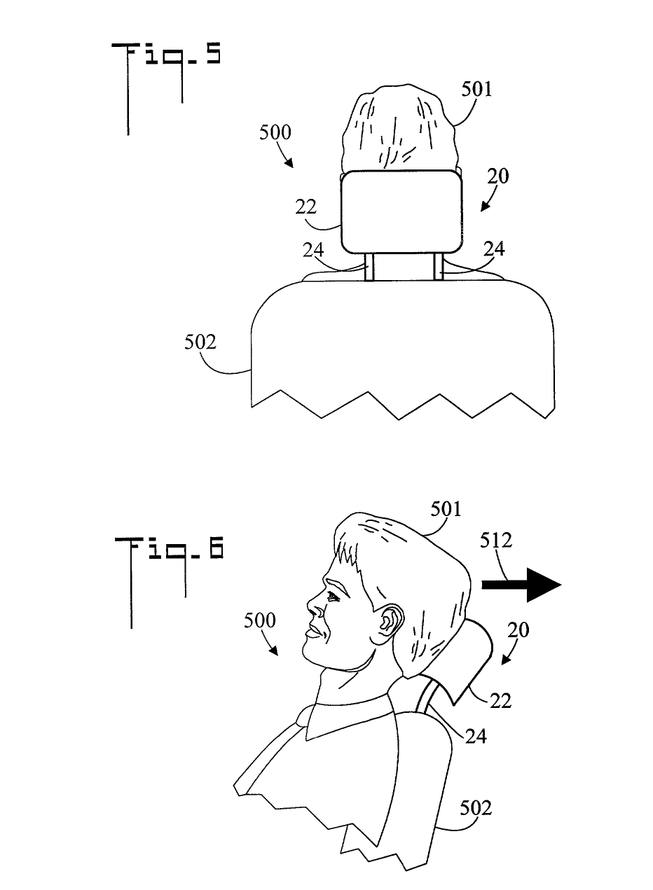

FIGS. 4 and 5 are side elevation and rear elevation views, respectively, of a passenger 500 sitting in a vehicle seat 502 having a permanently deformable headrest, generally designated 20, in accordance with the present invention. Permanently deformable headrest 20 has a padded portion 22 which engages the head 501 of the passenger 500. Permanently deformable headrest 20 additionally includes a permanently deformable structure, so that when the passenger's head 501 is thrown back against headrest 20 during a rear end collision, the permanently deformable structure is permanently deformed in a rearward direction, thereby absorbing the kinetic energy of the passenger's head 501. In a preferred embodiment of the present invention, the permanently deformable structure includes at least one permanently deformable post 24 which mounts headrest 20 to vehicle seat 502. In the shown embodiment, permanently deformable headrest 20 is connected to vehicle seat 502 by two permanently deformable support posts 24.

FIG. 6 is a side elevation view of the passenger's head 501 being thrown back in direction 512 against permanently deformable headrest 20 causing headrest 20 to bend toward the rear of the vehicle (also in direction 512). During this process, much of the kinetic energy of the passenger's head 501 is dissipated or dampened.

FIG. 7 is a side elevation view of the passenger's head 501 being thrown forward in direction 514. Because permanently deformable headrest 20 permanently bent to the rear in direction 512, the subsequent forward whipping of the passenger's head 501 in direction 514 is greatly reduced. This substantially lessens the possibility of a whiplash injury.

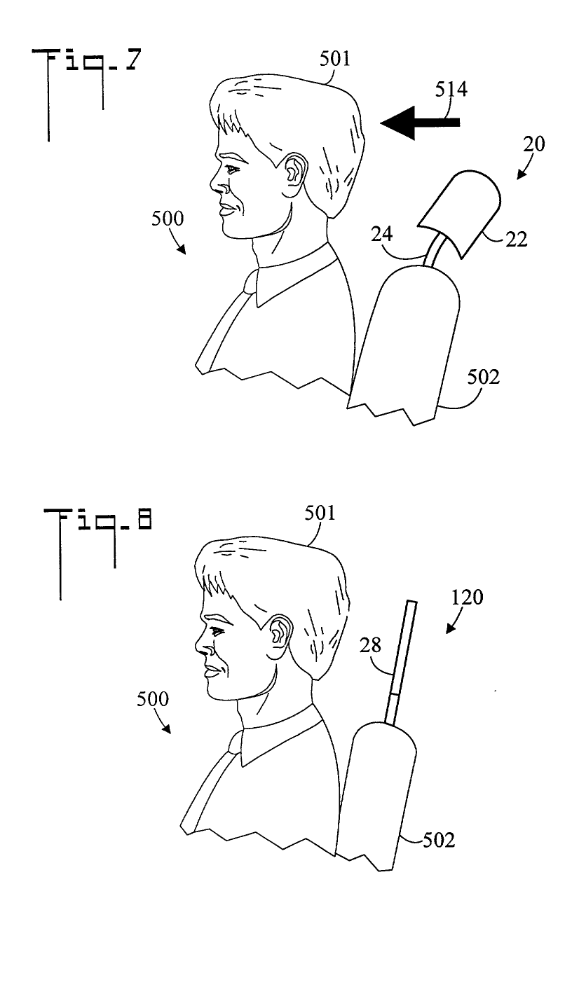

FIGS. 8 and 9 are side and rear elevation views respectively of a second embodiment of the permanently deformable headrest, generally designated as 120. It may be appreciated that the padding which would normally surround headrest 120 is not shown so that the internal structure is visable. In this embodiment, the permanently deformable structure includes at least one horizontal permanently deformable member 26. For example, the member 26 could comprise a rod which spans a distance between two support structures 28 which are mounted on the top of vehicle seat 502. In the shown preferred embodiment, a plurality of vertically spaced horizontal permanently deformable members 26 are employed.

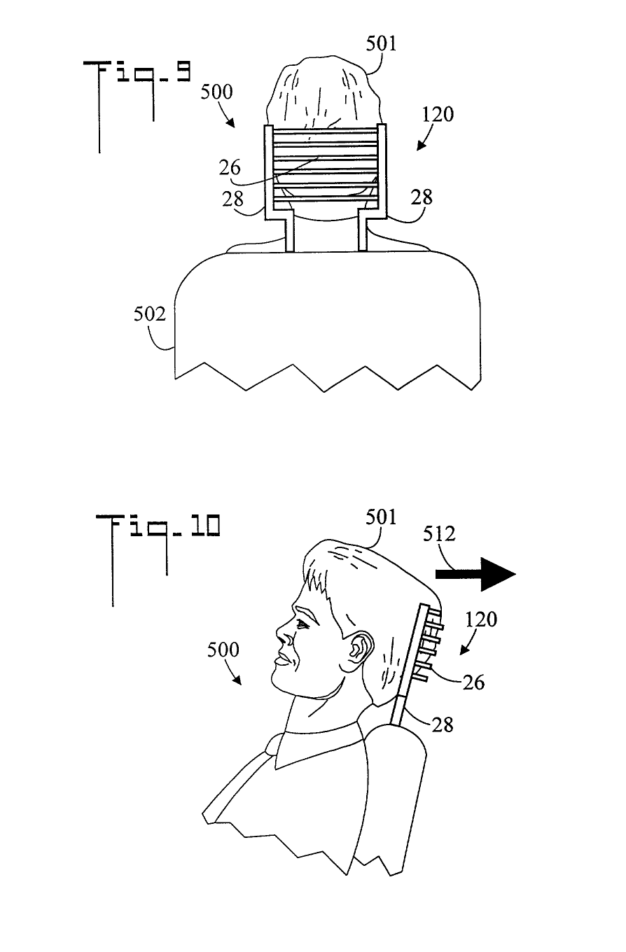

FIG. 10 is a side elevation view of the passenger's head 501 being thrown back in direction 512 against permanently deformable headrest 120. It can be seen that members 26 have permanently deformed rearwardly due to the force of the passenger's head 501, thereby dissipating the kinetic energy of the passenger's head 501.

FIG. 11 is a side elevation view of the passenger's head 501 being thrown forward in direction 514. Because permanently deformable headrest 120, and particularly deformable members 26, permanently bent to the rear in direction 512, the subsequent forward whipping of the passenger's head 501 in direction 514 is greatly reduced. This substantially lessens the possibility of a whiplash injury.

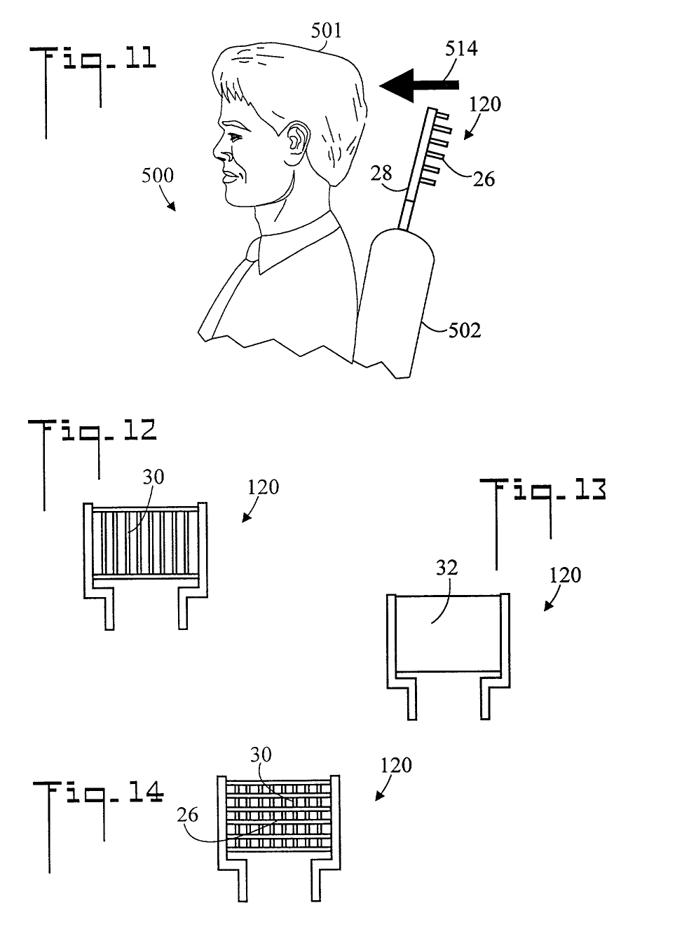

FIG. 12 is an alternative version of the second embodiment 120. In this embodiment, the permanently deformable structure includes at least one vertical permanently deformable member 30. In the shown preferred embodiment, a plurality of horizontally spaced vertical permanently deformable members 30 are employed.

FIG. 13 is another alternative version of the second embodiment 120. In this embodiment, the permanently deformable structure includes a sheet 32 of permanently deformable material.

FIG. 14 is a third alternative version of the second embodiment 120. In this embodiment both horizontal 26 and vertical 30 permanently deformable members are utilized.

In a preferred embodiment, the permanently deformable structure of the present invention is fabricated from soft steel, which will permanently deform when subjected to the force of the rearwardly moving head 501 of the passenger. It may be appreciated that other permanently deformable materials could also be employed in the present invention, so long as the material will dissipate a portion of the kinetic energy of the head 501 of the passenger.

It may also be appreciated that in embodiment 120, the support structure 28 could also be fabricated from permanently deformable material.

In terms of use, a method for reducing whiplash in a rear end collision comprises:

providing a vehicle seat having a top portion;

providing a passenger sitting in the vehicle seat;

providing a permanently deformable headrest having a permanently deformable structure;

installing the permanently deformable headrest on the top portion of the vehicle seat; and,

involving the vehicle in a rear end collision, so that the passenger's head is thrown back against the headrest, thereby permanently deforming the headrest in a rearward direction.

Obviously, after the headrest of the present invention has been bent, it must be replaced. Therefore, the method also includes the steps of:

removing the deformed headrest from the vehicle seat;

providing a new permanently deformable headrest; and,

installing the new permanently deformable headrest on the top portion of the vehicle seat.

The preferred embodiments of the invention described herein are exemplary and numerous modifications, dimensional variations, and rearrangements can be readily envisioned to achieve an equivalent result, all of which are intended to be embraced within the scope of the appended claims.

I claim:

1. A permanently deformable headrest for a vehicle seat, comprising:
said headrest including a permanently deformable structure, so that when a passenger's head is thrown back against said headrest during a rear end collision, said structure is permanently deformed in a rearward direction, thereby absorbing much of the kinetic energy of the passenger's head.

2. A permanently deformable headrest according to claim 1, further including:
said permanently deformable structure including at least one permanently deformable post which mounts said headrest to the vehicle seat.

3. A permanently deformable headrest according to claim 1, further including:
said permanently deformable structure including at least one horizontal permanently deformable member.

4. A permanently deformable headrest according to claim 3, further including:
a plurality of vertically spaced horizontal permanently deformable members.

5. A permanently deformable headrest according to claim 1, further including:
said permanently deformable structure including at least one vertical permanently deformable member.

6. A permanently deformable headrest according to claim 5, further including:
a plurality of horizontally spaced vertical permanently deformable members.

7. A permanently deformable headrest according to claim 1, further including:
a sheet of permanently deformable material.

8. A method for reducing whiplash in a rear end collision, comprising:
providing a vehicle having a vehicle seat having a top portion;
providing a passenger sitting in said vehicle seat;
providing a permanently deformable headrest having a permanently deformable structure;
installing said permanently deformable headrest on said top portion of said vehicle seat; and,
involving said vehicle in a rear end collision, so that the passenger's head is thrown back against said headrest, thereby permanently deforming said headrest in a rearward direction.

9. The method of claim 8, further including:
removing said deformed headrest from said vehicle seat;
providing a new permanently deformable headrest; and,
